(19) United States
(12) Patent Application Publication
(10) Pub. No.: US 2025/0101830 A1
(43) Pub. Date: Mar. 27, 2025

(54) HYDRAULIC SYSTEM AND METHOD FOR DOWNHOLE SLEEVE HORIZON SELECTION AND OPENING CONTROL

(71) Applicants: CHINA NATIONAL OFFSHORE OIL (CHINA) CO., LTD., Beijing (CN); BEIJING RESEARCH CENTER OF CNOOC (CHINA) CO., LTD., Beijing (CN)

(72) Inventors: Zhong LI, Beijing (CN); Liangbin XU, Beijing (CN); Baitao FAN, Beijing (CN); Leixiang SHENG, Beijing (CN); Dongsheng HE, Beijing (CN); Mengbo LI, Beijing (CN); Yan ZHENG, Beijing (CN)

(21) Appl. No.: 18/834,844

(22) PCT Filed: Mar. 15, 2022
(86) PCT No.: PCT/CN2022/080894

§ 371 Date: Jul. 31, 2024

(30) Foreign Application Priority Data
Dec. 2, 2021 (CN) 202111461911.0

(51) Int. Cl. E21B 34/08; F15B 13/04; F15B 15/16

(52) U.S. Cl. CPC E21B 34/08; F15B 13/04; F15B 15/16

(57) ABSTRACT

A hydraulic system includes a horizon selection short section comprising a group of hydraulic input ports, a group of hydraulic output ports, and a first group of hydraulic control valves connected therebetween, configured to control the opening and closing of the group of hydraulic output ports through the group of hydraulic control valves; a high and low pressure selection short section including a group of hydraulic connectors, a group of high and low pressure output ports and an oil return ports, and a second group of hydraulic control valves connected therebetween. The group of hydraulic connectors are connected to the group of hydraulic output ports, and are configured to control the opening and closing of the group of high and low pressure output ports and the oil return port through the input mode and pressurization adjustment of the second group of hydraulic control valves and the horizon selection short section.

### TECHNICAL FIELD

The present invention relates to the field of oil and gas production technology, and specifically to a hydraulic system and a method for downhole sleeve horizon selection and opening control.

### BACKGROUND

In oil and gas production, oil and gas wells may pass through multiple underground oil and gas layers, and each of the production of oil and gas layer needs to be managed separately to improve production efficiency. The downhole flow control valve is a key control device for controlling the inflow of each production layer. By using the throttling function of the flow control valve, one or more production layers can be closed, opened or throttled to achieve separate control of the flow of different production layers or branches. The flow control valve can adjust the pressure, fluid flow rate, and wellbore inflow dynamics between production layers in real time, realize multi-layer co-production, realize real-time control and optimization of oil reservoir production, control water cone gas invasion, accelerate production, and improve recovery rate.

A set of flow control valves needs to be installed for each production layer in the downhole. Usually, the fully hydraulically controlled flow control valve comprises two parts: horizon selection and opening control. The horizon selection determines the downhole target layer. After the target layer is selected, the opening of the target layer is controlled to control the downhole flow of the target layer, while any operations on the sleeves of other horizons are not performed. It is simple and feasible to use electric control to determine the downhole horizon, but under the condition of downhole high temperature and high pressure the life of electronic components will be greatly shortened. Some hydraulic control methods also have been proposed, but the systems are relatively complex and costly.

Therefore, how to effectively control the production of oil and gas layers in a relatively simple and low-cost manner is a research direction in this field.

### SUMMARY

### Technical Problem

In view of this, the present invention aims to provide a hydraulic system and method for downhole sleeve horizon selection and opening control, so as to realize the production control of oil and gas layers simply and conveniently.

### Technical Solution

The present invention discloses a hydraulic system for downhole sleeve horizon selection and opening control, wherein the hydraulic system comprises:

A horizon selection short section, comprising a group of hydraulic input ports and a group of hydraulic output ports, and a first group of hydraulic control valves connected between the group of hydraulic input ports and the group of hydraulic output ports, configured to control the opening and closing of the group of hydraulic output ports through the group of hydraulic control valves;

A high and low pressure selection short section, comprising a group of hydraulic connection ports and a group of high and low pressure output ports and an oil return port, and a second group of hydraulic control valves connected between the group of hydraulic connection ports and the group of high and low pressure output ports and the oil return port, wherein the group of hydraulic connection ports are respectively connected to the group of hydraulic output ports in one-to-one correspondence, and configured to control the opening and closing of the group of high and low pressure output ports and the oil return port through the input mode and pressurization adjustment of the second group of hydraulic control valves and the horizon selection short section.

According to one embodiment of the present invention, the system comprises a multi-layer control system, each one of the multi-layer control system comprises the horizon selection short section and the high and low pressure selection short section connected to each other, and the multi-layer control system is provided to be connected in parallel.

According to one embodiment of the present invention, the hydraulic system comprises a six-layer control system, and the number of the group of hydraulic input ports is three.

According to one embodiment of the present invention, the horizon selection short section also comprises three oil passages, the first group of hydraulic control valves comprises two normally open hydraulic control one-way valves and four normally closed hydraulic control one-way valves, and the two ends of the three oil passages are respectively provided with corresponding hydraulic input ports and hydraulic output ports, wherein a normally open hydraulic control one-way valve and a normally closed hydraulic control one-way valve are sequentially provided on the first oil passage, two normally closed hydraulic control one-way valves are sequentially provided on the second oil passage, and a normally closed hydraulic control one-way valve is provided on the third oil passage, a normally open hydraulic control one-way valve led out from the input port of the second oil passage and the normally open hydraulic control one-way valve on the first oil passage are mutually controlled, and the other normally closed hydraulic control one-way valves are mutually controlled, and finally five hydraulic output ports are led out.

According to an embodiment of the present invention, the high and low pressure selection short section further comprises an output oil return passage and other eight oil passages. The second group of hydraulic control valves comprises two normally open hydraulic control one-way valves and six normally closed hydraulic control one-way valves. A one-way valve is provided on each oil passage. Four oil passages form one group, so as to form two groups of symmetrical parallel oil passages totally. In each group, two oil passages are provided with normally open hydraulic control one-way valves and normally closed hydraulic control one-way valves with the same flow direction, and the other two oil passages are provided with normally closed hydraulic control one-way valves with different flow directions from the two oil passages, and are provided to be mutually controlled; the output oil return passage is provided in parallel with the two groups of oil passages.

According to one embodiment of the present invention, the system further comprises a sleeve, the sleeve comprises a two-stage telescopic cylinder inside the wall and radial holes distributed on the wall connecting the inside and the outside thereof, the two-stage telescopic cylinder comprises a first single-stage cylinder and a second single-stage cylinder; the first single-stage cylinder comprises a first single-stage cylinder left chamber, a first single-stage cylinder right chamber and a first single-stage cylinder piston; the second single-stage cylinder comprises a second single-stage cylinder left chamber, a second single-stage cylinder middle chamber, a second single-stage cylinder right chamber and a second single-stage cylinder piston; the cylinder body of the second single-stage cylinder is connected to the piston rod of the first single-stage cylinder; the radial hole is a flow passage for oil and gas in the downhole production layer; the output ports of the high and low pressure selection short section are respectively connected to each chamber of the sleeve in one-to-one correspondence.

The present invention also proposes a method for using the hydraulic system for downhole sleeve horizon selection and opening control, the method comprising:

By setting different hydraulic pressurization sequences at the input port to activate the horizon selection short sections at different horizons, by controlling the pressure value of the corresponding hydraulic pipeline, different high and low pressure combinations are input to change the direction of outlet oil delivery and oil return of the high and low pressure selection short sections of the corresponding horizons, so as to be configured to control different actions of the pistons in the sleeves at the corresponding horizons, thereby realizing the opening control of the corresponding horizon sleeves.

According to one embodiment of the present invention, the output port of the high and low pressure selection short section is connected to the piston cylinder of the two-stage hydraulic telescopic sleeve, and the sleeve is provided with a group of radial through holes at different positions, and the radial through holes can be opened or blocked by controlling the oil input or oil return of different piston cylinders, so as to obtain different numbers of flow outlets.

According to one embodiment of the present invention, when the first single-stage cylinder piston and the second single-stage cylinder piston are in different positions, the piston rod end of the two-stage telescopic cylinder is brought to different positions to block or open part or all of the radial holes, thereby realizing the flow regulation function of the downhole flow control valve.

According to one embodiment of the present invention, when pressurizing, at the input ports, one input port is reserved as the oil return port, and other input ports are selected as pressurizing ports. The pressure of the pressurizing ports is set to be the same or different as needed; before each pressurizing, the radial holes of the sleeve are first blocked, and then the opening adjustment action is performed.

### Beneficial Effects

The present invention adopts a simple one-way valve combination to realize downhole horizon selection and opening control by using the pressurization sequence and high and low pressure combination of the hydraulic pipeline, which has the advantages of being a simple solution, easy opening control and the like.

### BRIEF DESCRIPTION OF THE DRAWINGS

FIG. 1 is a schematic diagram of an intelligent completion flow control decoder and a sleeve according to an embodiment of the present invention;

FIG. 2 is a schematic diagram of the hydraulic pressure of a horizon selection short section according to an embodiment of the present invention;

FIG. 3 is a schematic diagram of the hydraulic pressure of a high and low pressure selection short section according to an embodiment of the present invention;

FIG. 4 is a schematic diagram of a downhole flow control sleeve according to an embodiment of the present invention;

FIG. 5 is a wiring diagram of a horizon selection short section according to an embodiment of the present invention;

FIG. 6 is an action diagram of the downhole flow control sleeve opening 1 according to an embodiment of the present invention;

FIG. 7 is an action diagram of the downhole flow control sleeve opening 2 according to an embodiment of the present invention;

FIG. 8 is an action diagram of the downhole flow control sleeve opening 3 according to an embodiment of the present invention;

FIG. 9 is an action diagram of the downhole flow control sleeve opening 4 according to an embodiment of the present invention.

### DETAILED DESCRIPTION

The following will describe the preferred embodiments of the present invention in detail in conjunction with the accompanying drawings so as to more clearly understand the purpose, features and advantages of the present invention. It should be understood that the embodiments shown in the accompanying drawings are not intended to limit the scope of the present invention, but are only intended to illustrate the essential spirit of the technical solution of the present invention.

The present invention activates the horizon selection short sections of different horizons by setting different hydraulic pressure sequences at the input port, and inputs different high and low pressure combinations by controlling the pressure value of the corresponding hydraulic pipeline to change the direction of the outlet oil delivery and oil return of the high and low pressure selection short section outlet of the corresponding horizon, so as to be configured to control the different actions of the piston in the corresponding horizon sleeve, thereby realizing the opening control of the corresponding horizon sleeve.

The hydraulic system for downhole sleeve horizon selection and opening control of the present invention mainly comprises:

a horizon selection short section, comprising a group of hydraulic input ports and a group of hydraulic output ports, and a first group of hydraulic control valves connected between the group of hydraulic input ports and the group of hydraulic output ports, configured to control the opening and closing of the group of hydraulic output ports through the group of hydraulic control valves;

a high and low pressure selection short section, comprising a group of hydraulic connection ports and a group of high and low pressure output ports and an oil return port, and a second group of hydraulic control valves connected between the group of hydraulic connection ports and the group of high and low pressure output ports and the oil return port, wherein the group of hydraulic connection ports are respectively connected to the group of hydraulic output ports in one-to-one correspondence, and configured to control the opening and closing of the group of high and low pressure output ports and the oil return port through the input mode and pressurization adjustment of the second group of hydraulic control valves and the horizon selection short section.

The following is an explanation to an implementation method for six-layer flow control using three input hydraulic pipelines as control system input. However, it is not limited to the number of inputs, the number of layers and the opening control.

The implementation method of the present invention is to independently realize the control requirement of each of the four openings of the downhole sleeves in six layer. Through a special pressurization sequence, the horizon selection short section of the corresponding horizon decoder is activated, and by controlling the pressure value of the corresponding hydraulic pipeline, a specific high and low pressure combination is performed, and the direction of outlet oil delivery and oil return of the corresponding horizon decoder is changed, thereby the different actions of the two-stage piston in the corresponding horizon sleeve is controlled, and then the four openings of the corresponding horizon sleeve is realized. The sleeve is connected to the oil pipe, and the hydraulic oil controls the opening size of the sleeve, and the opening size of the sleeve controls the flow size of the oil production.

The special pressurization sequence can open the hydraulic oil passage of the corresponding horizon in turn, while other horizons are not opened. By changing the high pressure and low pressure of the hydraulic control pipeline, the high pressure passage or low pressure oil passage in the high and low pressure selection short section of the decoder can be connected, so that the flow direction of the inlet and outlet of the decoder can be changed, thereby realizing the four openings of the sleeve, and the flow control of each target layer can be realized.

According to one embodiment of the present invention, three hydraulic pipelines are connected to six downhole hydraulic control systems in sequence from the ground hydraulic station to the bottom of the well, while the three hydraulic pipelines are connected to the ground hydraulic control equipment. That is, the downhole hydraulic control systems of each horizon are connected in parallel first and are connected to the three hydraulic pipelines. The first hydraulic input pipeline, the second hydraulic input pipeline and the third hydraulic input pipeline may all be made of stainless steel pipelines.

Each downhole hydraulic control system comprises a horizon selection short section, five hydraulic connection pipelines between short sections, a high and low pressure selection short section and five hydraulic output pipelines. The five hydraulic output pipelines are connected to the sleeve to control the opening of the sleeve. The horizon selection short section and the high and low pressure selection short section can both be included in the decoder.

The horizon selection short section comprises two normally open hydraulic control one-way valves, four normally closed hydraulic control one-way valves and three oil passages; the high and low pressure selection short section comprises two normally open hydraulic control one-way valves, six normally closed hydraulic control one-way valves, eight oil passages and one oil return passage. The horizon selection short section and the high and low pressure selection short section are connected by five hydraulic connection pipelines. The high and low pressure selection short section and the downhole flow control sleeve are connected by five hydraulic output pipelines. The hydraulic control system has the function of downhole horizon selection and downhole sleeve opening control. Three hydraulic pipelines can be used to control the opening of each of the downhole sleeves in six layers, thereby realizing the control of the flow of each target layer.

If it is required to control the flow of one layer thereof at one time and not control the other layers, the three input ports of the horizon selection short section of each layer may be connected correspondingly to three hydraulic pipelines in different orders, that is, the three hydraulic pipelines can have six combinations according to the different connection order, as shown in FIG. 5; and if it is required to perform the same control on several layers thereof, it may be provided that the connection order of these layers is the same and is different from the connection order of other layers, so that the same operation may be performed on several layers thereof.

Specifically, an embodiment of the present invention provides a hydraulic downhole intelligent flow control valve decoder control solution, as shown in FIG. 1, the decoder system comprises a first hydraulic input pipeline 1, a second hydraulic input pipeline 2, a third hydraulic input pipeline 3, a horizon selection short section 4, a first high pressure connecting pipeline 5, a first low pressure connecting pipeline 6, a second high pressure connecting pipeline 7, a second low pressure connecting pipeline 8, a first oil return connecting pipeline 9, a high and low pressure selection short section 10, a first high pressure output pipeline 11, a first low pressure output pipeline 12, a second high pressure output pipeline 13, a second low pressure output pipeline 14 and a first oil return output pipeline 15; the decoder is connected to the downhole flow control sleeve 16 through five hydraulic output pipelines.

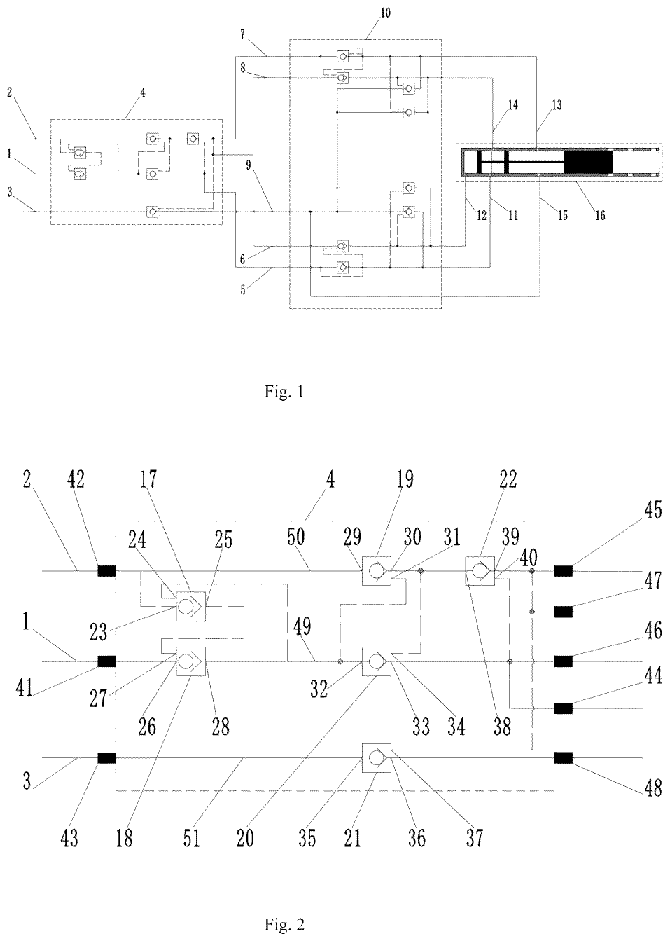

As shown in FIG. 2, the left end of the horizon selection short section 4 is connected to the three hydraulic input pipelines through three hydraulic input pipeline joints, and the three hydraulic input pipeline joints are respectively a first hydraulic input pipeline joint 41, a second hydraulic input pipeline joint 42 and a third hydraulic input pipeline joint 43. The right end of the horizon selection short section 4 is connected to five hydraulic connection pipelines through five hydraulic connection pipeline joints, and the five hydraulic connection pipeline joints are respectively the first high pressure connection pipeline joint 44, the second high pressure connection pipeline joint 45, the first low pressure connection pipeline joint 46, the second low pressure connection pipeline joint 47 and the first oil return connection pipeline joint 48. The first oil passage 49, the second oil passage 50 and the third oil passage 51 are distributed in the horizon selection short section 4.

As shown in FIG. 2, the horizon selection short section 4 further comprises a first normally open hydraulically controlled one-way valve 17, a second normally open hydraulically controlled one-way valve 18, a first normally closed hydraulically controlled one-way valve 19, a second normally closed hydraulically controlled one-way valve 20, a third normally closed hydraulically controlled one-way valve 21 and a fourth normally closed hydraulically controlled one-way valve 22; the left end of the first normally open hydraulically controlled one-way valve 17 is provided with a first normally open oil inlet 23 and a first normally open control port 24, and the right end of the first normally open hydraulically controlled one-way valve 17 is provided with a first normally open oil outlet 25; the left end of the second normally open hydraulically controlled one-way valve 18 is provided with a second normally open oil inlet 26 and a second normally open control port 27, and the right end of the second normally open hydraulically controlled one-way valve 18 is provided with a second normally open oil outlet 28; the left end of the first normally closed hydraulically controlled one-way valve 19 is provided with a first normally closed oil inlet 29, the right end of the first normally closed hydraulically controlled one-way valve 19 is provided with a first normally closed oil outlet 30 and a first normally closed control port 31; the left end of the second normally closed hydraulically controlled one-way valve 20 is provided with a second normally closed oil inlet 32, and the right end of the second normally closed hydraulically controlled one-way valve 20 is provided with the second normally closed oil outlet 33 and a second normally closed control port 34; the left end of the third normally closed hydraulically controlled one-way valve 21 is provided with a third normally closed oil inlet 35, and the right end of the third normally closed hydraulically controlled one-way valve 21 is provided with a third normally closed oil outlet 36 and a third normally closed control port 37; the left end of the fourth normally closed hydraulically controlled one-way valve 22 is provided with a fourth normally closed oil inlet 38, and the right end of the fourth normally closed hydraulically controlled one-way valve 22 is provided with a fourth normally closed oil outlet 39 and a fourth normally closed control port 40.

The first oil passage 49 connects the first hydraulic input pipeline joint 41, the second normally open oil inlet 26, the second normally open oil outlet 28, the second normally closed oil inlet 32, the second normally closed oil outlet 33, the first normally open control port 24, the first high pressure connecting pipeline joint 44 and the first low pressure connecting pipeline joint 46; the second oil passage 50 connects the second hydraulic input pipeline joint 42, the first normally open oil inlet 23, the first normally open oil outlet 25, the first normally closed oil inlet 29, the first normally closed oil outlet 30, the fourth normally closed oil inlet 38, the fourth normally closed oil outlet 39, the second normally open control port 27, the second normally closed control port 34, the third normally closed control port 37, the second high pressure connecting pipeline joint 45 and the second low pressure connecting pipeline joint 47; the third oil passage 51 connects the third hydraulic input pipeline joint 43, the third normally closed oil inlet 35, the third normally closed oil outlet 36 and the first oil return connecting pipeline joint 48.

Further, the first normally open hydraulically controlled one-way valve 17 comprises a first normally open steel ball, a first normally open spring, a first normally open spring seat, a first normally open steel ball push rod, a first normally open oil inlet, a first normally open oil outlet and a first normally open control port; similarly, the second normally open hydraulically controlled one-way valve 18 comprises a second normally open steel ball, a second normally open spring, a second normally open spring seat, a second normally open steel ball push rod, a second normally open oil inlet, a second normally open oil outlet and a second normally open control port; the first normally closed hydraulically controlled one-way valve 19 comprises a first normally closed steel ball, a first normally closed spring, a first normally closed spring seat, a first normally closed steel ball push rod, a first normally closed oil inlet, a first normally closed oil outlet and a first normally closed control port; similarly, the second normally closed hydraulically controlled one-way valve 20 comprises a second normally closed steel ball, a second normally closed spring, a second normally closed spring seat, a second normally closed steel ball push rod, a second normally closed oil inlet, a second normally closed oil outlet and a second normally closed control port; the third normally closed hydraulically controlled one-way valve 21 comprises a third normally closed steel ball, a third normally closed spring, a third normally closed spring seat, a third normally closed steel ball push rod, a third normally closed oil inlet, a third normally closed oil outlet and a third normally closed control port; the fourth normally closed hydraulically controlled one-way valve 22 comprises a fourth normally closed steel ball, a fourth normally closed spring, a fourth normally closed spring seat, a fourth normally closed steel ball push rod, a fourth normally closed oil inlet, a fourth normally closed oil outlet and a fourth normally closed control port. The hydraulically controlled one-way valve structure is a prior art and will not be described here.

Wherein, five hydraulic connection pipelines are connected to the five input ports of the subsequent high and low pressure selection short section 10.

The first high pressure connecting pipeline, the second high pressure connecting pipeline, the first low pressure connecting pipeline, the second low pressure connecting pipeline and the first oil return connecting pipeline may all be made of stainless steel pipelines.

The left end of the high and low pressure selection short section 10 is connected to five hydraulic connecting pipelines through five hydraulic connecting pipeline joints, and the five hydraulic connecting pipeline joints are respectively the third high pressure connecting pipeline joint 84, the fourth high pressure connecting pipeline joint 85, the third low pressure connecting pipeline joint 86, the fourth low pressure connecting pipeline joint 87 and the second oil return connecting pipeline joint 88.

The right end of the high and low pressure selection short section 10 is connected to five hydraulic output pipelines through five hydraulic output pipeline joints, and the five hydraulic output pipeline joints are respectively the first high pressure output pipeline joint 89, the second high pressure output pipeline joint 90, the first low pressure output pipeline joint 91, the second low pressure output pipeline joint 92 and the first oil return output pipeline joint 93.

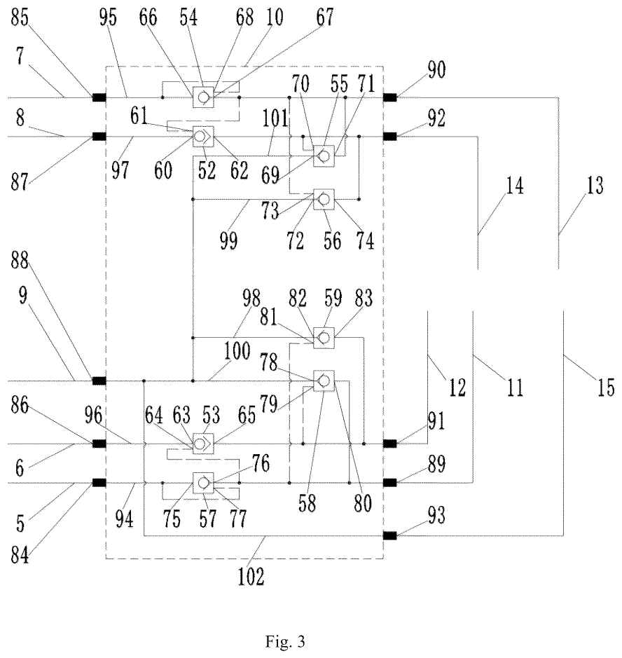

As shown in FIG. 3, the high and low pressure selection short section 10 comprises a third normally open hydraulically controlled one-way valve 52, a fourth normally open hydraulically controlled one-way valve 53, a fifth normally closed hydraulically controlled one-way valve 54, a sixth normally closed hydraulically controlled one-way valve 55, a seventh normally closed hydraulically controlled one-way valve 56, an eighth normally closed hydraulically controlled one-way valve 57, a ninth normally closed hydraulically controlled one-way valve 58 and a tenth normally closed hydraulically controlled one-way valve 59.

The left end of the third normally open hydraulically controlled one-way valve 52 is provide with a third normally open oil inlet 60 and a third normally open control port 61, and the right end of the third normally open hydraulically controlled one-way valve 52 is provide with a third normally open oil outlet 62; the left end of the fourth normally open hydraulically controlled one-way valve 53 is provide with a fourth normally open oil inlet 63 and a fourth normally open control port 64, and the right end of the second normally open hydraulically controlled one-way valve 53 is provide with a fourth normally open oil outlet 65; the left end of the fifth normally closed hydraulically controlled one-way valve 54 is provide with a fifth normally closed oil inlet 66, and the right end of the fifth normally closed hydraulically controlled one-way valve 54 is provide with a fifth normally closed oil outlet 67 and a fifth normally closed control port 68; the left end of the sixth normally closed hydraulically controlled one-way valve 55 is provide with a sixth normally closed oil outlet 69 and a sixth normally closed control port 70, and the right end of the sixth normally closed hydraulically controlled one-way valve 55 is provide with a sixth normally closed oil inlet 71; the left end of the seventh normally closed hydraulically controlled one-way valve 56 is provide with the seventh normally closed oil outlet 72 and the seventh normally closed control port 73, and the right end of the seventh normally closed hydraulically controlled one-way valve 56 is provide with the seventh normally closed oil inlet 74; the left end of the eighth normally closed hydraulically controlled one-way valve 57 is provide with the eighth normally closed oil inlet 75, and the right end of the eighth normally closed hydraulically controlled one-way valve 57 is provide with the eighth normally closed oil outlet 76 and the eighth normally closed control port 77; the left end of the ninth normally closed hydraulically controlled one-way valve 58 is provide with the ninth normally closed oil outlet 78 and the ninth normally closed control port 79, and the right end of the ninth normally closed hydraulically controlled one-way valve 58 is provide with the ninth normally closed oil inlet 80; the left end of the tenth normally closed hydraulically controlled one-way valve 59 is provide with the tenth normally closed oil outlet 81 and the tenth normally closed control port 82, and the right end of the tenth normally closed hydraulically controlled one-way valve 59 is provide with the tenth normally closed oil inlet 83.

The first high pressure oil passage 94, the second high pressure oil passage 95, the first low pressure oil passage 96, the second low pressure oil passage 97, the first high pressure oil return passage 98, the second high pressure oil return passage 99, the first low pressure oil return passage 100, the second low pressure oil return passage 101 and the first output oil return passage 102 are distributed in the high pressure and low pressure selection short section 10.

The first high pressure oil passage 94 is connected to the third high pressure connecting pipeline joint 84, the eighth normally closed oil inlet 75, the eighth normally closed oil outlet 76, the eighth normally closed control port 77, the fourth normally open control port 64, the tenth normally closed control port 82 and the first high pressure output pipeline joint 89; the first low pressure oil passage 96 is connected to the third low pressure connecting pipeline joint 86, the fourth normally open oil inlet 63, the fourth normally open oil outlet 65, the ninth normally closed control port 79 and the first low pressure output pipeline joint 91; The second high pressure oil passage 95 is connected to the fourth high pressure connecting pipeline joint 85, the fifth normally closed oil inlet 66, the fifth normally closed oil outlet 67, the fifth normally closed control port 68, the third normally open control port 61, the seventh normally closed control port 73 and the second high pressure output pipeline joint 90; the second low pressure oil passage 97 is connected to the fourth low pressure connecting pipeline joint 87, the third normally open oil inlet 60, the third normally open oil outlet 62, the sixth normally closed control port 70 and the second low pressure output pipeline joint 92.

Further, the third normally open hydraulically controlled one-way valve 52 comprises a third normally open steel ball, a third normally open spring, a third normally open spring seat, a third normally open steel ball push rod, a third normally open oil inlet, a third normally open oil outlet and a third normally open control port; similarly, the fourth normally open hydraulically controlled one-way valve comprises a fourth normally open steel ball, a fourth normally open spring, a fourth normally open spring seat, a fourth normally open steel ball push rod, a fourth normally open oil inlet, a fourth normally open oil outlet and a fourth normally open control port; the fifth normally closed hydraulically controlled one-way valve comprises a fifth normally closed steel ball, a fifth normally closed spring, a fifth normally closed spring seat, a fifth normally closed steel ball push rod, a fifth normally closed oil inlet, a fifth normally closed oil outlet and a fifth normally closed control port; similarly, the sixth normally closed hydraulically controlled one-way valve comprises a sixth normally closed steel ball, a sixth normally closed spring, a sixth normally closed spring seat, a sixth normally closed steel ball push rod, a sixth normally closed oil inlet, a sixth normally closed oil outlet and a sixth normally closed control port; the seventh normally closed hydraulically controlled one-way valve comprises the seventh normally closed steel ball, the seventh normally closed spring, the seventh normally closed spring seat, the seventh normally closed steel ball push rod, the seventh normally closed oil inlet, the seventh normally closed oil outlet and the seventh normally closed control port; the eighth normally closed hydraulically controlled one-way valve comprises the eighth normally closed steel ball, the eighth normally closed spring, the eighth normally closed spring seat, the eighth normally closed steel ball push rod, the eighth normally closed oil inlet, the eighth normally closed oil outlet and the eighth normally closed control port; the ninth normally closed hydraulically controlled one-way valve comprises the ninth normally closed steel ball, the ninth normally closed spring, the ninth normally closed spring seat, the ninth normally closed steel ball push rod, the ninth normally closed oil inlet, the ninth normally closed oil outlet and the ninth normally closed control port; the tenth normally closed hydraulically controlled one-way valve comprises the tenth normally closed steel ball, the tenth normally closed spring, the tenth normally closed spring seat, the tenth normally closed steel ball push rod, the tenth normally closed oil inlet, the tenth normally closed oil outlet and the tenth normally closed control port. The structure of the hydraulically controlled one-way valve is a prior art and will not be repeated here.

Five hydraulic output pipelines are used to connect the five input ports of the downhole flow control sleeve 16.

The first high pressure output pipeline, the second high pressure output pipeline, the first low pressure output pipeline, the second low pressure output pipeline and the first oil return output pipeline may all be made of stainless steel pipelines.

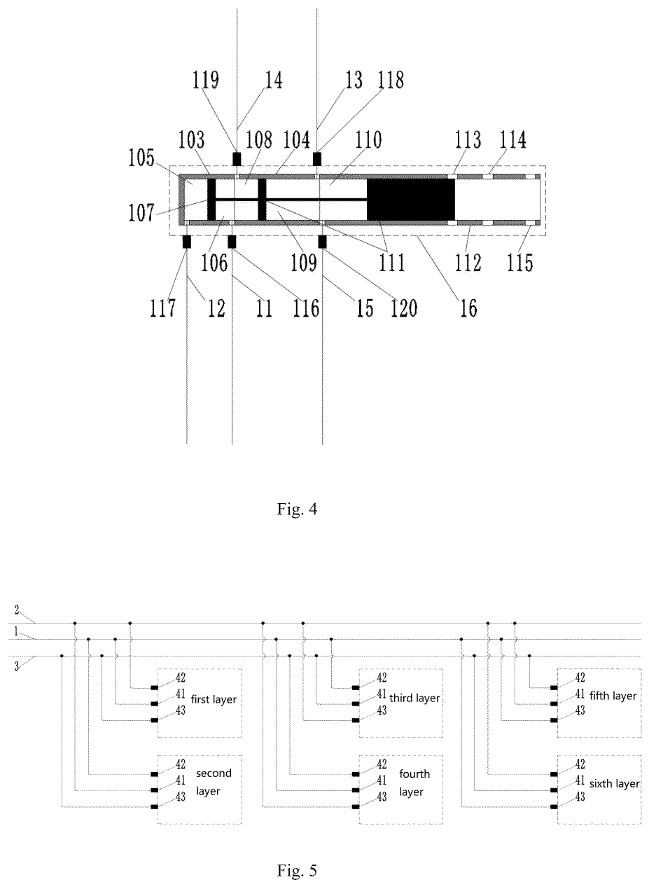

As shown in FIG. 4, the downhole flow control sleeve 16 comprises a first single-stage cylinder 103 and a second single-stage cylinder 104 nested; the first single-stage cylinder 103 comprises a first single-stage cylinder left chamber 105, a first single-stage cylinder right chamber 106 and a first single-stage cylinder piston 107; the second single-stage cylinder 104 comprises a second single-stage cylinder left chamber 108, a second single-stage cylinder middle chamber 109, a second single-stage cylinder right chamber 110 and a second single-stage cylinder piston 111.

Radial holes 113, 114 and 115 are distributed on the outer wall 112 of the downhole flow control sleeve; five joints connected to the five hydraulic output pipelines are provided on the downhole flow control sleeve 16, including the first high pressure sleeve pipeline joint 116, the first low pressure sleeve pipeline joint 117, the second high pressure sleeve pipeline joint 118, the second low pressure sleeve pipeline joint 119 and the first oil return sleeve pipeline joint 120; the first high pressure sleeve pipeline joint 116 is connected to the right chamber 106 of the first single-stage cylinder; the first low pressure sleeve pipeline joint 117 is connected to the left chamber 105 of the first single-stage cylinder; the second high pressure sleeve pipeline joint 118 is connected to the middle chamber 109 of the second single-stage cylinder; the second low pressure sleeve pipeline joint 119 is connected to the left chamber 108 of the second single-stage cylinder; the first oil return sleeve pipeline joint 120 is connected to the right chamber 110 of the second single-stage cylinder.

As shown in FIGS. 2 and 5, an embodiment of the present invention provides a method for downhole oil and gas production horizon selection, which realizes that three hydraulic input pipelines control downhole six layers, and the connection sequence between each layer and the three hydraulic input pipelines is different, that is, one layer is selected to be controlled each time. Among the three hydraulic input pipelines, any two may be used as pressure input pipelines, and the third can be used as an oil return pipeline; the three pipelines can have six wiring combinations. Specifically, the following steps may be included (the pressurization sequence is adjustable):

1) The pressurization sequence is: pressurize the first hydraulic input pipeline 1 first, and then pressurize the second hydraulic input pipeline 2. The flow situation of the horizon selection short section in the first layer is following: first pressurizes the first hydraulic input pipeline 1, the hydraulic oil on the first oil passage 49 passes through the first hydraulic input pipeline joint 41, the second normally open oil inlet 26, the second normally open oil outlet 28, the first normally open control port 24 and the first normally closed control port 31, closes the first normally open hydraulic control check valve 17 and opens the first normally closed hydraulic control check valve 19; then pressurizes the second hydraulic input pipeline 2, the hydraulic oil on the second oil passage 50 passes through the second hydraulic input pipeline joint 42, the first normally closed oil inlet 29, the first normally closed oil outlet 30 and the second normally closed control port 34, opens the second normally closed hydraulic control check valve 20; the hydraulic oil on first oil passage 49 enters the fourth normally closed control port 40, opens the fourth normally closed hydraulic control check valve 22; the hydraulic oil on the second oil passage 50 enters the third normally closed control port 37, opens the third normally closed hydraulic control check valve 21; the first normally closed hydraulic control check valve 19, the second normally closed hydraulic control check valve 20, the third normally closed hydraulic control check valve 21 and the fourth normally closed hydraulic control check valve 22 are all opened, then the horizon selection short section in the first layer is activated.

The flow situation of the horizon selection short section in the second layer is following: first pressurizes the first hydraulic input pipeline 1, the hydraulic oil on the second oil passage 50 passes through the second hydraulic input pipeline joint 42, the first normally open oil inlet 23, the first normally open oil outlet 25, the second normally open control port 27 and the first normally closed oil inlet 29, and closes the second normally open hydraulic control check valve 18; then pressurizes the second hydraulic input pipeline 2, the hydraulic oil on the first oil passage 49 passes through the first hydraulic input pipeline joint 41 and the second normally closed oil inlet 26; the first normally closed hydraulic control check valve 19 and the second normally open hydraulic control check valve 18 are both closed, then the second horizon selection short section is not activated.

The flow situation of the horizon selection short section in the third layer is following: first pressurizes the first hydraulic input pipeline 1, the hydraulic oil on the second oil passage 50 passes through the second hydraulic input pipeline joint 42, the first normally open oil inlet 23, the first normally open oil outlet 25, the second normally open control port 27 and the first normally closed oil inlet 29, closes the second normally open hydraulic control check valve 18; then pressurizes the second hydraulic input pipeline 2, the hydraulic oil on the third oil passage 51 passes through the third hydraulic input pipeline joint 43 and the third normally closed oil inlet 35; the first normally closed hydraulic control check valve 19, the second normally closed hydraulic control check valve 20 and the third normally closed hydraulic control check valve 21 are all closed, then the third horizon selection short section is not activated;

The flow situation of the horizon selection short section in the fourth layer is following: first pressurizes the first hydraulic input pipeline 1, the hydraulic oil on the first oil passage 49 passes through the first hydraulic input pipeline joint 41, the second normally open oil inlet 26, the second normally open oil outlet 28, the first normally open control port 24 and the first normally closed control port 31, closes the first normally open hydraulic control check valve 17 and opens the first normally closed hydraulic control check valve 19; then pressurizes the second hydraulic input pipeline 2, the hydraulic oil on the third oil passage 51 passes through the third hydraulic input pipeline joint 43 and the third normally closed oil inlet 35; the second normally closed hydraulic control check valve 20, the third normally closed hydraulic control check valve 21 and the fourth normally closed hydraulic control check valve 22 are all closed, then the fourth horizon selection short section is not activated.

The flow situation of the horizon selection short section in the fifth layer is following: first pressurizes the first hydraulic input pipeline 1, and the hydraulic oil on the third oil passage 51 passes through the third hydraulic input pipeline joint 43 and the third normally closed oil inlet 35; then pressurizes the second hydraulic input pipeline 2, and the hydraulic oil on the first oil passage 49 passes through the first hydraulic input pipeline joint 41, the second normally open oil inlet 26, the second normally open oil outlet 28, the first normally open control port 24 and the first normally closed control port 31, closes the first normally opens hydraulically controlled one-way valve 17 and opens the first normally closed hydraulically controlled one-way valve 19; the second normally closed hydraulically controlled one-way valve 20, the third normally closed hydraulically controlled one-way valve 21 and the fourth normally closed hydraulically controlled one-way valve 22 are all in the closed state, and horizon selection short section in the fifth layer is not activated;

The flow situation of the horizon selection short section in the sixth layer is following: first pressurizes the first hydraulic input pipeline 1, the hydraulic oil on the third oil passage 51 passes through the third hydraulic input pipeline joint 43 and the third normally closed oil inlet 35; then pressurizes the second hydraulic input pipeline 2, the hydraulic oil on the second oil passage 50 passes through the second hydraulic input pipeline joint 42, the first normally open oil inlet 23, the first normally open oil outlet 25, the second normally open control port 27 and the first normally closed oil inlet 29, and closes the second normally opens hydraulic control check valve 18; the first normally closed hydraulic control check valve 19, the second normally closed hydraulic control check valve 20, the third normally closed hydraulic control check valve 21 and the fourth normally closed hydraulic control check valve 22 are all closed, then the horizon selection short section in the sixth layer is not activated.

2) Similarly, the pressurization sequence is: first pressurizes the second hydraulic input pipeline 2, and then pressurizes the first hydraulic input pipeline 1, such that the horizon selection short section in the second layer is activated, and the horizon selection short sections in the first layer, in the third layer, in the fourth layer, in the fifth layer and in the sixth layer are not activated.

3) Similarly, the pressurization sequence is: first pressurizes the third hydraulic input pipeline 3, and then pressurizes the first hydraulic input pipeline 1, such that the horizon selection short section in the third layer is activated, and the horizon selection short sections in the first layer, in the second layer, in the fourth layer, in the fifth layer and in the sixth layer are not activated.

4) Similarly, the pressurization sequence is: first pressurizes the first hydraulic input pipeline 1, and then pressurizes the third hydraulic input pipeline 3, then the horizon selection short section in the fourth layer is activated, and the horizon selection short section in the first layer, in the second layer, in the third layer, in the fifth layer, in the sixth layer are not activated.

5) Similarly, the pressurization sequence is: first pressurizes the second hydraulic input pipeline 2, and then pressurizes the third hydraulic input pipeline 3, such that the horizon selection short section in the fifth layer is activated, and the horizon selection short sections in the first layer, in the second layer, in the third layer, in the fourth layer and in the sixth layer are not activated.

6) Similarly, the pressurization sequence is: first pressurizes the third hydraulic input pipeline 3, and then pressurizes the second hydraulic input pipeline 2, such that the horizon selection short section in the sixth layer is activated, and the horizon selection short sections in the first layer, in the second layer, in the third layer, in the fourth layer and in the fifth layer are not activated.

As shown in FIGS. 1-4 and 6-9, the embodiment of the present invention provides a selecting method for downhole hydraulic high and low pressures, realizing four openings of the sleeve of the target layer, thereby controlling the flow of the target layer. Specifically, for example, by adjusting the structure and spring of each hydraulically controlled one-way valve of the high and low pressure selection short section, the opening pressure of the fifth and eighth normally closed hydraulically controlled one-way valves can be high pressure (for example, 10 MPa), the closing pressure of the third and fourth normally open hydraulically controlled one-way valves can be low pressure (for example, 5 MPa), and the opening pressure of the sixth, seventh, ninth and tenth normally closed hydraulically controlled one-way valves can be low pressure (for example, less than 5 MPa); by adjusting the structure and spring of each hydraulically controlled one-way valve of the horizon selection short section, both the opening pressure and closing pressure of each hydraulically controlled one-way valve can be low pressure (for example, less than 5 MPa); more specifically, the following steps can be included (the pressurizing sequence can be adjusted as needed):

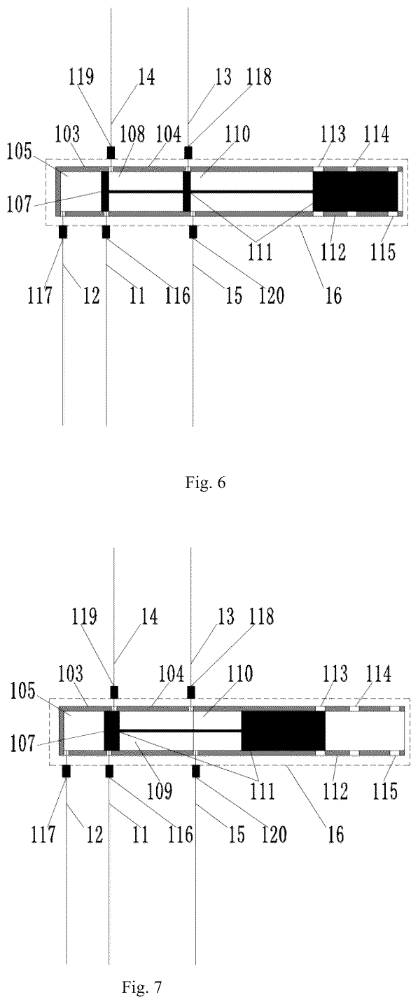

1) Before each pressurizing, no matter what state the downhole flow control sleeve 16 is in, the piston in the cylinder is first moved to the opening 1 (fully closed) as shown in FIG. 6: In FIG. 6, the first single-stage cylinder piston 107 is in the right limit position, the second single-stage cylinder piston 111 is in the right limit position, and the radial holes 113, 114 and 115 on the outer wall 112 of the downhole flow control sleeve are all closed.

2) First, low pressure is applied to the first hydraulic input pipeline 1, and then low pressure is applied to the second input hydraulic pipeline 2; after the hydraulic oil passes through the horizon selection short section 4 in the target layer, it flows into the first low pressure oil passage 96 and the second low pressure oil passage 97 through the third low pressure connecting pipeline joint 86 and the fourth low pressure connecting pipeline joint 87 of the high and low pressure selection short section 10 in the target layer; the low pressure hydraulic oil on the first low pressure oil passage 96 passes through the fourth normally open oil inlet 63, the fourth normally open oil outlet 65, the ninth normally closed control port 79, the first low pressure output pipeline joint 91, the first low pressure output pipeline 12 and the first low pressure sleeve pipeline joint 117, opens the ninth normally closed hydraulic control one-way valve 58; the hydraulic oil flows into the left chamber 105 of the first single-stage cylinder, and the first single-stage cylinder piston 107 is pushed rightward to the right limit position. The hydraulic oil in the right chamber 106 of the first single-stage cylinder flows back to the oil tank through the first high pressure sleeve pipeline joint 116, the ninth normally closed oil inlet 80 in the open state, the ninth normally closed oil outlet 78, the second oil return connecting pipeline joint 88, the first oil return connecting pipeline 9, the first oil return connecting pipeline joint 48, the third normally closed oil outlet 36 in the open state, the third normally closed oil inlet 35, the third hydraulic input pipeline joint 43 and the third hydraulic input pipeline 3; Similarly, the low pressure hydraulic oil on the second low pressure oil passage 97 passes through the third normally-open oil inlet 60, the third normally-open oil outlet 62, the sixth normally-closed control port 70, the second low pressure output pipeline joint 92, the second low pressure output pipeline 14 and the second low pressure sleeve pipeline joint 119, opens the sixth normally closed hydraulically controlled one-way valve 55; the hydraulic oil flows into the left chamber 108 of the second single-stage cylinder, and the piston 111 of the second single-stage cylinder is pushed rightward to the right limit position; the hydraulic oil in the middle chamber 109 of the second single-stage cylinder flows back to the oil tank through the second high pressure sleeve pipeline joint 118, the sixth normally closed oil inlet 71 in the open state, the sixth normally closed oil outlet 69, the second oil return connecting pipeline joint 88, the first oil return connecting pipeline 9, the first oil return connecting pipeline joint 48, the third normally closed oil outlet 36 in the open state, the third normally closed oil inlet 35, the third hydraulic input pipeline joint 43 and the third hydraulic input pipeline 3; the downhole flow control sleeve 16 is opened to an opening 1 (fully closed), as shown in FIG. 6.

3) First, low pressure is applied to the first hydraulic input pipeline 1, and then high pressure is applied to the second input hydraulic pipeline 2; the pressure of the hydraulic oil in the decoder is determined by the load, so low pressure is first applied to the first oil passage 49, the second oil passage 50, the first low pressure oil passage 96 and the second low pressure oil passage 97; the downhole flow control sleeve 16 first repeats the above step 2), that is, after the downhole flow control sleeve 16 is opened to the opening 1 (fully closed), the pressure on the second oil passage 50 and the second low pressure oil passage 97 rises to high pressure; the high pressure hydraulic oil on the second oil passage 50 passes through the horizon selection short section 4, and then flows into the second high pressure oil passage 95 through the fourth high pressure connecting pipeline joint 85 of the high and low pressure selection short section 10; the high pressure hydraulic oil on the second high pressure oil passage 95 passes through the fifth normally closed oil inlet 66, the fifth normally closed control port 68, the fifth normally closed oil outlet 67, the third normally open control port 61, the seventh normally closed control port 73, the second high pressure output pipeline joint 90, the second high pressure output pipeline 13 and the second high pressure sleeve pipeline joint 118, closes the third normally open hydraulic control one-way valve 52 and opens the seventh normally closed hydraulic control one-way valve 56; the high pressure hydraulic oil flows into the second single-stage cylinder middle chamber 109, the second single-stage cylinder piston 111 retreats leftward to the left limit position, the hydraulic oil in the left chamber 108 of the second single-stage cylinder flows back to the oil tank through the second low pressure sleeve pipeline joint 119, the seventh normally closed oil inlet 74 in the open state, the seventh normally closed oil outlet 72, the second oil return connection pipeline joint 88, the first oil return connection pipeline 9, the first oil return connection pipeline joint 48, the third normally closed oil outlet 36 in the open state, the third normally closed oil inlet 35, the third hydraulic input pipeline joint 43 and the third hydraulic input pipeline 3; the downhole flow control sleeve 16 is opened to an opening 2, as shown in FIG. 7.

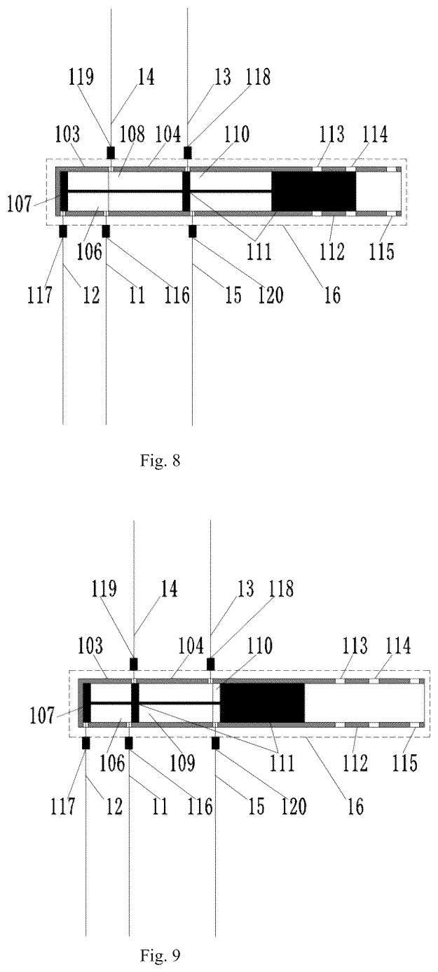

4) First, high pressure is applied to the first hydraulic input pipeline 1, and then low pressure is applied to the second input hydraulic pipeline 2; the pressure of the hydraulic oil in the decoder is determined by the load, so low pressure is first applied to the first oil passage 49, the second oil passage 50, the first low pressure oil passage 96 and the second low pressure oil passage 97; the downhole flow control sleeve 16 first repeats the above step 2), that is, after the downhole flow control sleeve 16 is opened to the opening 1 (fully closed), the pressure on the first oil passage 49 and the first low pressure oil passage 96 rises to high pressure; after the high pressure hydraulic oil on the first oil passage 49 passes through the horizon selection short section 4, and then flows into the first high pressure oil passage 94 through the third high pressure connecting pipeline joint 84 of the high and low pressure selection short section 10; the high pressure hydraulic oil on the first high pressure oil passage 94 passes through the eighth normally closed oil inlet 75, the eighth normally closed control port 77, the eighth normally closed oil outlet 76, the fourth normally open control port 64, the tenth normally closed control ports 81, the first high pressure output pipeline joint 89, the first high pressure output pipeline 11 and the first high pressure sleeve pipeline joint 116, closes the fourth normally open hydraulic control one-way valve 53 and opens the tenth normally closed hydraulic control one-way valve 59; the high pressure hydraulic oil flows into the right chamber 106 of the first single-stage cylinder, the first single-stage cylinder piston 107 retreats leftward to the left limit position, and the hydraulic oil in the left chamber 105 of the first single-stage cylinder flows back to the oil tank through the first low pressure sleeve pipeline joint 117, the tenth normally closed oil inlet 83 in the open state, the tenth normally closed oil outlet 82, the second oil return connection pipeline joint 88, the first oil return connection pipeline 9, the first oil return connection pipeline joint 48, the third normally closed oil outlet 36 in the open state, the third normally closed oil inlet 35, the third hydraulic input pipeline joint 43 and the third hydraulic input pipeline 3; the downhole flow control sleeve 16 is opened to an opening 3, as shown in FIG. 8.

5) First, high pressure is applied to the first hydraulic input pipeline 1, and then high pressure is applied to the second input hydraulic pipeline 2; the pressure of the hydraulic oil in the decoder is determined by the load, so low pressure is first applied to the first oil passage 49, the second oil passage 50, the first low pressure oil passage 96 and the second low pressure oil passage 97; the downhole flow control sleeve 16 first repeats the above step 2), that is, after the downhole flow control sleeve 16 is opened to the opening 1 (fully closed), the pressure on the first oil passage 49, the second oil passage 50, the first low pressure oil passage 96 and the second low pressure oil passage 97 rises to high pressure; after the high pressure hydraulic oil on the first oil passage 49 and the second oil passage 50 passes through the horizon selection short section 4, and flows into the first high pressure oil passage 94 and the second high pressure oil passage 95 through the third high pressure connecting pipeline joint 84, the fourth high pressure connecting pipeline joint 85 of the high and low pressure selection short section 10; the high pressure hydraulic oil on the first high pressure oil passage 94 passes through the eighth normally closed oil inlet 75, the eighth normally closed control port 77, the eighth normally closed oil outlet 76, the fourth normally open control port 64, the tenth normally closed control port 81, the first high pressure output pipeline joint 89, the first high pressure output pipeline 11 and the first high pressure sleeve pipeline joint 116, closes the fourth normally open hydraulically controlled one-way valve 53 and opens the tenth normally closed hydraulically controlled one-way valve 59; the high pressure hydraulic oil flows into the right chamber 106 of the first single-stage cylinder, the piston 107 of the first single-stage cylinder retreats leftward to the left limit position, and the hydraulic oil in the left chamber 105 of the first single-stage cylinder flow back to the oil tank through the first low pressure sleeve pipeline joint 117, the tenth normally closed oil inlet 83 in the open state, the tenth normally closed oil outlet 82, the second oil return connecting pipeline joint 88, the first oil return connecting pipeline 9, the first oil return connecting pipeline joint 48, the third normally closed oil outlet 36 in the open state, the third normally closed oil inlet 35, the third hydraulic input pipeline joint 43 and the third hydraulic input pipeline 3; the high pressure hydraulic oil on the second high pressure oil passage 95 passes through the fifth normally closed oil inlet 66, the fifth normally closed control port 68, the fifth normally closed oil outlet 67, the third normally open control port 61, the seventh normally closed control port 73, the second high pressure output pipeline joint 90, the second high pressure output pipeline 13 and the second high pressure sleeve pipeline joint 118, closes the hydraulic control check valve 52 and opens the seventh normally hydraulic control check valve 56; the high pressure hydraulic oil flows into the middle chamber 109 of the second single-stage cylinder, the second single-stage cylinder piston 111 retreats leftward to the left limit position, and the hydraulic oil in the left chamber 108 of the second single-stage cylinder flows back to the oil tank through the second low pressure sleeve pipeline joint 119, the seventh normally closed oil inlet 74 in the open state, the seventh normally closed oil outlet 72, the second oil return connection pipeline joint 88, the first oil return connection pipeline 9, the first oil return connection pipeline joint 48, the third normally closed oil outlet 36 in the open state, the third normally closed oil inlet 35, the third hydraulic input pipeline joint 43 and the third hydraulic input pipeline 3; the downhole flow control sleeve 16 is opened to an opening 4 (fully open), as shown in FIG. 9.

This embodiment can provide six wiring combinations according to the three hydraulic input pipelines, and can activate separately each of the downhole six layer decoders, thereby controlling the action of the flow control sleeve in the target oil and gas layer. Different pressure combinations of the two pressure input pipelines can be selected, namely low pressure-low pressure, low pressure-high pressure, high pressure-low pressure and high pressure-high pressure control, to achieve different movement forms of the first and second single-stage cylinder pistons, so that the flow control sleeve has four different openings, thereby achieving flow control of the target oil and gas layer. The present invention can achieve flow control of the downhole target layer without using downhole electronic equipment.

It should be noted that, in this article, the terms “center”, “upper”, “lower”, “left”, “right”, “vertical”, “horizontal”, “inside”, “outside” and the like indicate the orientation or position relationship based on the orientation or position relationship shown in the accompanying drawings, which is only for the convenience of describing the present invention and simplifying the description, rather than indicating or implying that the system or element referred to must have a specific orientation, be constructed and operated in a specific orientation, and therefore cannot be understood as a limitation of the present invention; relational terms such as “first” and “second” are only used to distinguish one entity or operation from another entity or operation, and do not necessarily require or imply any such actual relationship or order between these entities or operations. Moreover, the terms “include”, “comprises” or any other variants thereof are intended to cover non-exclusive inclusion, so that a process, method, article or device including a series of elements comprises not only those elements, but also other elements not explicitly listed, or also comprises elements inherent to such process, method, article or device. In the absence of further restrictions, the elements defined by the sentence “including a . . . ” do not exclude the existence of other identical elements in the process, method, article or device including the elements.

In addition, in the description of the present invention, it should be noted that, unless otherwise clearly specified and defined, the terms “installed”, “connected” and “connected” should be understood in a broad sense, for example, it can be a fixed connection, a detachable connection, or an integral connection; it can be a mechanical connection or an electrical connection; it can be a direct connection, or it can be an indirect connection through an intermediate medium, or it can be a connection between two elements. For ordinary technicians in this field, the specific meanings of the above terms in the present invention can be understood according to specific circumstances.

The above embodiments are only used to illustrate the present invention, in which the various components and devices of the embodiments can be changed, and each implementation method can be combined or deleted as needed. Not all components in the drawings are necessary. The general principles defined in this article can be implemented in other embodiments without departing from the spirit or scope of this application. Therefore, this application will not be limited to the embodiments described in this article, and all equivalent changes and improvements based on the technical solution of the present invention should not be excluded from the protection scope of the present invention.

1. A hydraulic system for downhole sleeve horizon selection and opening control, wherein the system comprises:
a horizon selection short section, comprising a group of hydraulic input ports and a group of hydraulic output ports, and a first group of hydraulic control valves connected between the group of hydraulic input ports and the group of hydraulic output ports, configured to control the opening and closing of the group of hydraulic output ports through the group of hydraulic control valves;
a high and low pressure selection short section, comprising a group of hydraulic connection ports and a group of high and low pressure output ports and an oil return port, and a second group of hydraulic control valves connected between the group of hydraulic connection ports and the group of high and low pressure output ports and the oil return port, wherein the group of hydraulic connection ports are respectively connected to the group of hydraulic output ports in one-to-one correspondence, and configured to control the opening and closing of the group of high and low pressure output ports and the oil return port through the input mode and pressurization adjustment of the second group of hydraulic control valves and the horizon selection short section.

2. The hydraulic system for downhole sleeve horizon selection and opening control according to claim 1, wherein the system comprises a multi-layer control system, each one of the multi-layer control system comprises the horizon selection short section and the high and low pressure selection short section connected to each other, and the multi-layer control system is provided to be connected in parallel.

3. The hydraulic system for downhole sleeve horizon selection and opening control according to claim 2, wherein the hydraulic system comprises a six-layer control system, and the number of the group of the hydraulic input ports is three.

4. The hydraulic system for downhole sleeve horizon selection and opening control according to claim 2, wherein the horizon selection short section further comprises three oil passages, the first group of hydraulic control valves comprises two normally open hydraulic control one-way valves and four normally closed hydraulic control one-way valves, and the two ends of the three oil passages are respectively provided with corresponding the hydraulic input ports and the hydraulic output ports, wherein a normally open hydraulic control one-way valve and a normally closed hydraulic control one-way valve are sequentially provided on the first oil passage, two normally closed hydraulic control one-way valves are sequentially provided on the second oil passage, and a normally closed hydraulic control one-way valve is provided on the third oil passage, a normally open hydraulic control one-way valve led out from the input port of the second oil passage and the normally open hydraulic control one-way valve on the first oil passage are mutually controlled, and the other normally closed hydraulic control one-way valves are mutually controlled, and finally five hydraulic output ports are led out.

5. The hydraulic system for downhole sleeve horizon selection and opening control according to claim 3, wherein the high and low pressure selection short section further comprises an output oil return passage and other eight oil passages, the second group of hydraulic control valves comprises two normally open hydraulic control one-way valves and six normally closed hydraulic control one-way valves, one-way valve is provided on each oil passage, four oil passages form one group so as to form two groups of symmetrical parallel oil passages totally, in each group, two oil passages are provided with normally open hydraulic control one-way valves and normally closed hydraulic control one-way valves with the same flow direction, and the other two oil passages are provided with normally closed hydraulic control one-way valves with different flow directions from the two oil passages, and are provided to be mutually controlled; the output oil return passage is provided in parallel with the two groups of oil passages.

6. (Currently Amened) The hydraulic system for selecting the horizon and controlling the opening of the downhole sleeve according to claim 1, wherein the system further comprises a sleeve, the sleeve comprises a two-stage telescopic hydraulic cylinder inside the wall and radial holes distributed on the wall connecting the inside and the outside, the two-stage telescopic hydraulic cylinder comprises a first single-stage hydraulic cylinder and a second single-stage hydraulic cylinder; the first single-stage hydraulic cylinder comprises a first single-stage hydraulic cylinder left chamber, a first single-stage hydraulic cylinder right chamber and a first single-stage hydraulic cylinder piston; the second single-stage hydraulic cylinder comprises a second single-stage hydraulic cylinder left chamber, a second single-stage hydraulic cylinder middle chamber, a second single-stage hydraulic cylinder right chamber and a second single-stage hydraulic cylinder piston; the cylinder body of the second single-stage hydraulic cylinder is connected to the piston rod of the first single-stage hydraulic cylinder; the radial hole is a flow passage for oil and gas in the downhole production layer; the output ports of the high and low pressure selection short section are respectively connected to each chamber of the sleeve in one-to-one correspondence.

7. A method for using hydraulic system for downhole sleeve horizon selection and opening control according to claim 1, wherein the method comprises:
by setting different hydraulic pressurization sequences at the input port to activate the horizon selection short sections at different horizons, and by controlling the pressure value of the corresponding hydraulic pipeline, different high and low pressure combinations are input to change the direction of the outlet oil delivery and oil return of the high and low pressure selection short sections at the corresponding horizons, so as to be configured to control different actions of the pistons in the sleeves at the corresponding horizons, thereby realizing the opening control of the sleeves at the corresponding horizons.

8. The method for using the hydraulic system according to claim 7, wherein the output port of the high and low pressure selection short sections is connected to the piston cylinder of the two-stage hydraulic telescopic sleeve, and the sleeve is provided with a group of radial through holes at different positions, and the radial through holes can be opened or blocked by controlling the oil input or oil return of different piston cylinders, so as to obtain different numbers of flow outlets.

9. The method for using the hydraulic system according to claim 1, wherein when the first single-stage cylinder piston and the second single-stage cylinder piston are in different positions, the piston rod end of the two-stage telescopic cylinder is brought to different positions to block or open part or all of the radial holes, thereby realizing the flow regulation function of the downhole flow control valve.

10. The method for using the hydraulic system according to claim 9, wherein when pressurizing, at the input ports, one input port is reserved as the oil return port, and other input ports are selected as pressurizing ports, and the pressure of the pressurizing ports is set to be the same or different as needed; before each pressurizing, the radial holes of the sleeve are first blocked, and then the opening adjustment action is performed.
